(19) United States
(12) Patent Application Publication
(10) Pub. No.: US 2015/0115185 A1
(43) Pub. Date: Apr. 30, 2015

(54) Fluid Flow Regulating Device Having High Resistance To Corrosion

(71) Applicant: Westport Power Inc., Vancouver (CA)

(72) Inventors: Giulio Brizzolari, Nuvolento (IT); Roberto Defilippi, Botticino (IT)

(21) Appl. No.: 14/583,675

(22) Filed: Dec. 27, 2014

Related U.S. Application Data
(63) Continuation of application No. PCT/IB2013/055201, filed on Jun. 25, 2013.

(30) Foreign Application Priority Data
Jun. 28, 2012 (IT) BS2012A000097

(51) Int. Cl. F02M 21/02; F16L 25/02; F16K 27/00

(52) U.S. Cl. CPC F02M 21/0296; F16K 27/00; F16L 25/021
USPC 251/148

(57) ABSTRACT

A device has a body made of a first material, for example aluminum, and a component coupled to the body and made of a second material different from the first. The device further includes, between the body and the component, a spacer element of annular shape arranged around the component so as to be in contact on the one hand against the body and on the other against an abutment surface of such component, preventing, or at least reducing, direct contact between the component and the body. In some embodiments, the spacer element is made of a third material having an electric potential value between the first two materials.

### CROSS-REFERENCE TO RELATED APPLICATIONS

This application is a continuation of International Application No. PCT/IB2013/055201 having a filing date of Jun. 25, 2013, entitled “Fluid Flow Regulating Device, Particularly for Automotive Gas Systems, Having High Resistance to Corrosion”, which claimed priority benefits from Italian patent application No. BS2012A000097 filed on Jun. 28, 2012. The present application also claims priority benefits from the '097 Italian application. The PCT/IB2013/055201 international application is hereby incorporated by reference herein in its entirety.

### FIELD OF THE INVENTION

A fluid flow regulating device, in particular for automotive gas systems, has a body made of a first material and a component coupled to the body made of a second material different from the first. More specifically, a multi-function valve for automotive gas systems, having a valve body in aluminum to which one or more stainless steel fittings are attached for connecting one or more respective pipes to the valve body.

### BACKGROUND OF THE INVENTION

The application to motor vehicles of transformation systems also able to fuel thermic motors by means of LPG or methane gas (CNG), thereby realizing overall a mixed fuel supply (gas) has been known of for years. Automotive gas systems typically have a gas tank, a multi-function valve installed on the gas tank, a pressure regulator which brings the gas to the pressure needed to fuel the thermic motor, and a series of ducts with relative accessories.

Currently, in automotive gas systems, multi-function valves have a valve body made of brass, while the various devices and/or fittings assembled to the valve body are mostly made from other metals. For example, the fittings are typically made of stainless steel.

Brass has an intermediate electric potential value compared to other metals. Thus, during corrosion resistance tests (such as those required by current legislation and/or imposed by car manufacturers) the electric arc triggered between the valve body and the fittings, whatever material the latter are made from, does not typically cause galvanic corrosion above the limits imposed.

There is a demand for valves, and devices in general, which are as lightweight as possible, especially in automotive gas systems with more than one cylinder and consequently with more than one multifunction valve. Multi-function valves have recently been developed with valve bodies made of aluminum. These valves weigh 40% less than previous valves and permit a drastic reduction of the overall weight of the system. This reduces weight has positive repercussions on vehicle performance.

One problem that has been encountered however is due to the fact that aluminum has a low electric potential. Consequently, if the aluminum associates with a metal material having a medium/high electric potential (such as, for example, the stainless steel often used for various valve components) it acts as an anode and is thus subject to galvanic corrosion phenomena.

Current valves with aluminum valve bodies and stainless steel components do not satisfy current corrosion resistance tests. During these tests the corrosion reaches the sealed zone between the valve body and fittings which leads to gas leaks. In order to overcome this drawback, an application of a layer of grease between the aluminum valve body and the stainless steel fittings has been suggested to prevent contact between these two materials and thereby prevent galvanic corrosion. However, it is difficult to control the application process and the layer can be partially removed during movement of the component and/or during the final assembly of the gas system. What is needed is a fluid flow regulating device that has greater resistance to corrosion than the prior art, but still utilizes an aluminum valve body and stainless steel components.

### SUMMARY OF THE INVENTION

The current fluid flow regulating device is based on the idea of placing, between the body and each component coupled to it, a spacer element of an annular shape arranged around the component in such a way as to be in contact on one side against the body and on the other against an abutment surface of the component, preventing (or at least reducing) the direct contact between the component and the body. A spacer element of a material with an intermediate electric potential between that of the material of the body and that of the material of the component makes any electric arcs which are triggered between the material of the spacer element and the material of the component and between the material of the spacer element and the material of the body less intense than those which would be triggered between the materials of the body and of the component in the absence of the spacer element. The use of the spacer element results in a less aggressive corrosion being generated from the arcs.

In one embodiment, the body is aluminum and the component coupled to the body is stainless steel.

In some embodiments, the device is a multi-function valve and has, as components coupled to the valve body, one or more fittings each for attaching a respective pipe to the valve body.

### BRIEF DESCRIPTION OF THE DRAWINGS

FIG. 1 shows a perspective view of a multifunction valve for an automotive, gas system according to the prior art.

FIG. 2 shows an axial cross-section of the coupling between the valve body and one of the fittings of the multi-function valve in FIG. 1.

FIG. 3 shows a perspective view of a multifunction valve for an automotive gas system.

FIG. 4 shows an axial cross-section of the coupling between the valve body and one of the fittings of the multi-function valve in FIG. 3.

FIGS. 5a to 5c show in axial cross-section some embodiments of the spacer element positioned between the valve body and the fitting of the multi-function valve in FIG. 3.

### DETAILED DESCRIPTION OF PREFERRED EMBODIMENT(S)

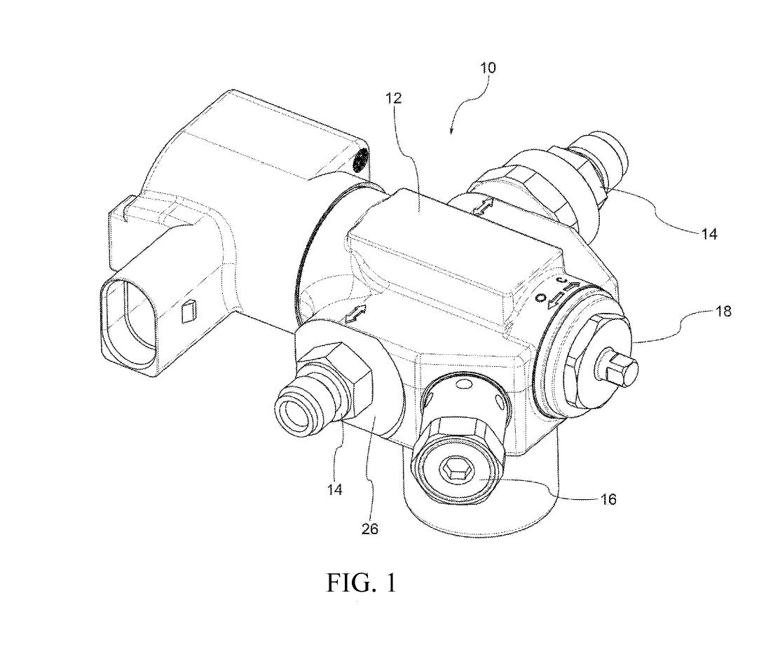

FIG. 1 shows multifunction valve 10 according to the prior art. Multifunction valve 10 includes valve body 12, one or more fittings 14 (in this case two fittings) assembled to valve body 12 to each permit the attachment of a respective pipe (not shown) to valve body 12, as well as a series of parts or devices of various types indicated by reference numerals 16 and 18.

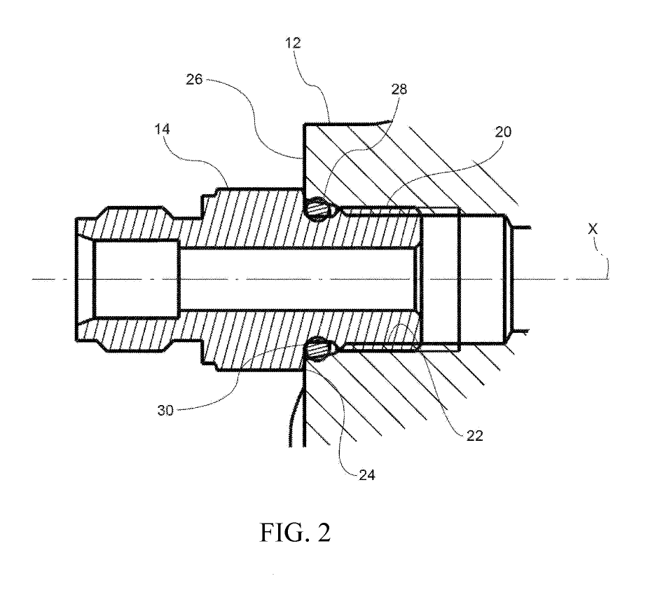

FIG. 2 shows the coupling between one of the two fittings 14 with valve body 12. Fitting 14 includes threaded cylindrical coupling portion 20 which is screwed into corresponding threaded cylindrical seat 22 provided in valve body 12. Fitting 14 further presents abutment surface 24 lying in a plane perpendicular to the axis (indicated as x) of coupling portion 20, which in the assembled condition of valve 10 abuts against flat surface 26 of valve body 12 extending around seat 22. O-ring 28 is mounted on fitting 14 between coupling portion 20 and abutment surface 24 and, in the assembled condition of valve 10, makes a seal against conical intake surface 30 of seat 22 of valve body 12. Such coupling enables the valve to satisfy the leak test required by many entities such as governments and car manufacturers.

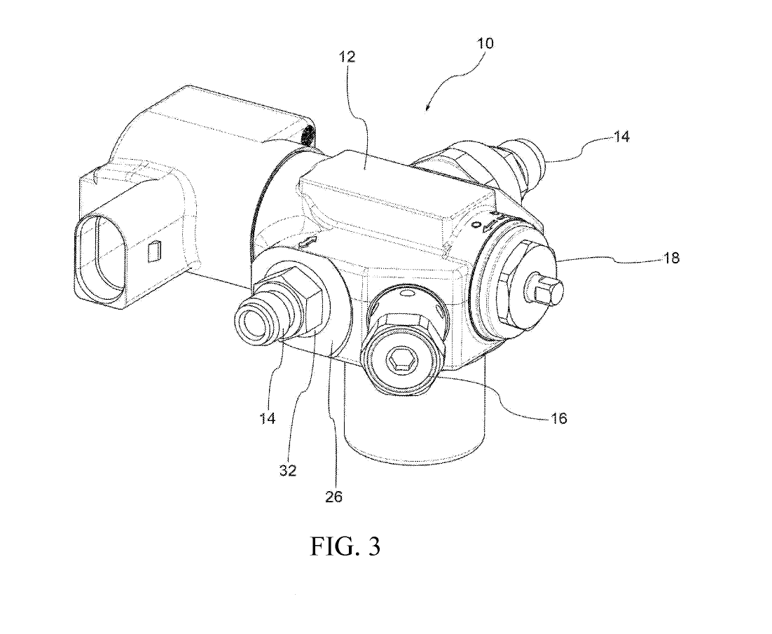

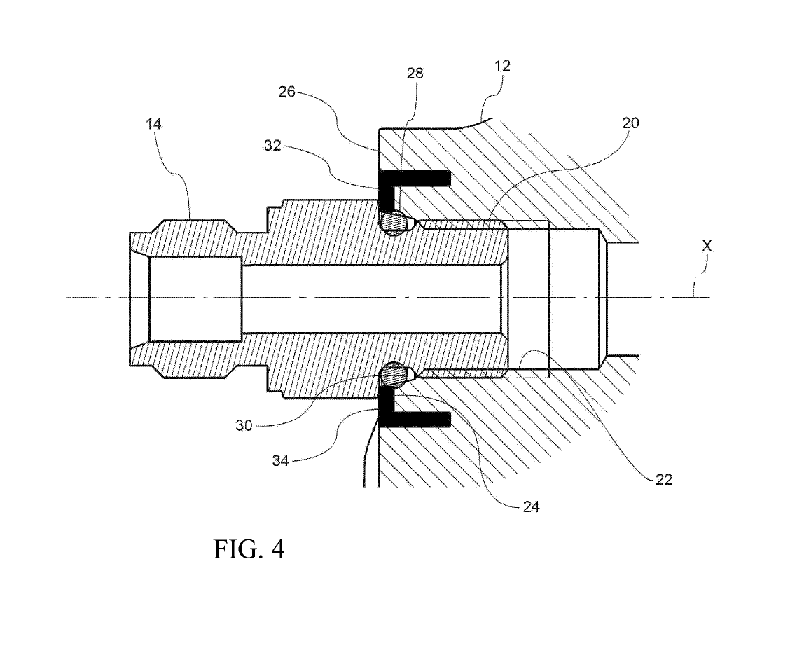

With reference initially to FIGS. 3 and 4, in which parts or elements identical or corresponding to those in FIGS. 1 and 2 (prior art) have been given the same reference numerals. Reference numeral 10 globally denotes a multi-function valve (such as for example a fluid flow regulating device), which in some embodiments is configured to be installed on a gas tank (not shown) of an automotive gas system. Valve 10 fundamentally comprises valve body 12, one or more fittings 14 (in the example two fittings) assembled to valve body 12 to each permit the attachment of a respective pipe (not shown) to the valve body 12, as well as a series of members or devices of various types indicated by reference numerals 16 and 18. In some embodiments, valve body 12 is made of aluminum, while fittings 14 are made of stainless steel.

As shown in detail in FIG. 4, each fitting 14 comprises coupling portion 20 which couples it to valve body 12. In FIG. 4, coupling portion 20 is made as a threaded cylindrical portion and is screwed into corresponding threaded cylindrical seat 22 provided in valve body 12. Fitting 14 further presents abutment surface 24, lying in a plane perpendicular to the axis (indicated as x) of coupling portion 20. O-ring 28 is mounted on fitting 14 between coupling portion 20 and abutment surface 24 and, in the assembled condition of valve 10, forms a seal against conical intake surface 30 of seat 22 of valve body 12.

Spacer element 32 reduces the galvanic corrosion produced in particular conditions of humidity and/or salinity and as a result of the difference in electric potential between the aluminum of valve body 12 and the stainless steel of fittings 14. Spacer element 32 is placed between valve body 12 and each fitting 14 and has an annular shape. Spacer element 32 is arranged around seat 22 of valve body 12 in such a way as to be in contact on one side against valve body 12 and on the other against abutment surface 24 of fitting 14. This arrangement prevents direct contact between valve body 12 and fitting 14. In some embodiment spacer element 32 is made of a material having an electric potential value between that of the aluminum and that of the stainless steel. In the same or other embodiments, space element 32 is made of a metal material, such as, but not limited to, brass or copper.

Spacer element 32 is housed in valve body 12 so only one flat surface 34 is exposed outside of valve body 12. In some embodiments, flat surface 34, is positioned flush with flat surface 26 formed by valve body 12 around seat 22 and which abutment surface 24 of fitting 14 is in contact with. This way, spacer element 32 does not entail variations in the dimensions of the valve.

The material of spacer element 32 is chosen so as to have an intermediate electric potential value between that of aluminum and stainless steel. Consequently during corrosion resistance tests, electric arcs are triggered both between spacer element 32 and fitting 14, and between spacer element 32 and valve body 12. These electric arcs are less intense than those which would be triggered between fitting 14 and valve body 12 the absence of spacer element 32. These less intense electric arcs generate less aggressive corrosion.

In order to preserve valve body 12, in particular the sealing zone between valve body 12 and fitting 14 (the zone which O-ring 30 presses on), spacer element 32 is sized and shaped to increase the distance which the pitting generated by corrosion covers to reach the sealing zone.

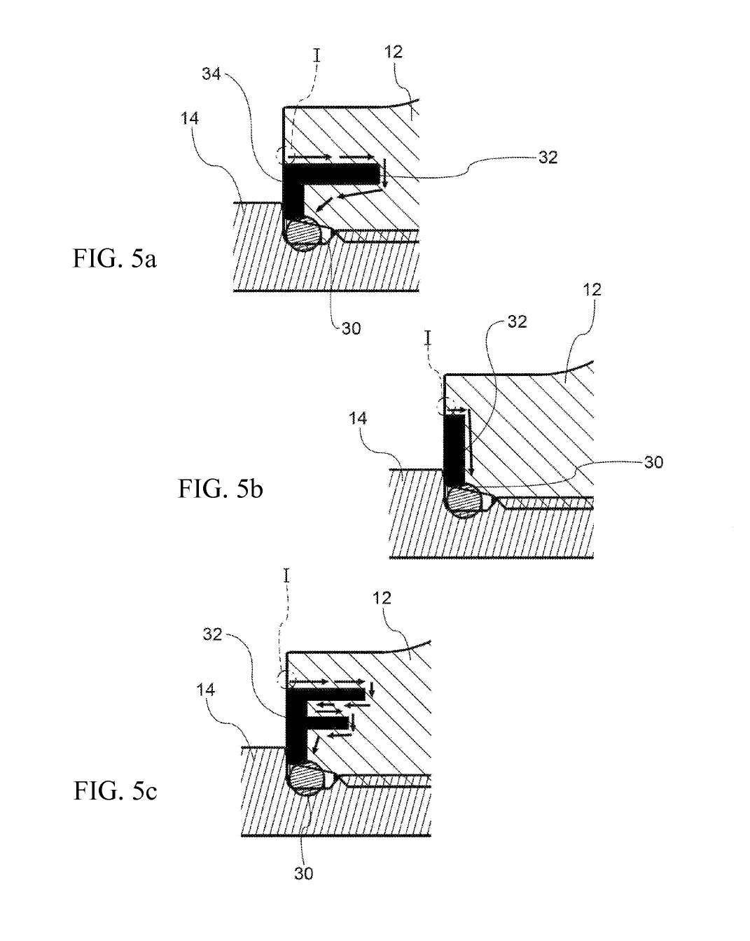

FIGS. 5a to 5c show possible shapes of the cross-section of spacer element 32. The path of the pitting, starting from the triggering zone of the corrosion (marked by circle I with dotted line), is shown by the arrows. The zone is positioned around the contact point between valve body 12 and fitting 14 and is exposed to the outside environment in which valve 10 is located.

The L and F shapes shown in FIGS. 5a and 5c permit a significant lengthening of the pitting path without excessively increasing the difference between the outer diameter and inner diameter of spacer element 32 when compared to the shape shown in FIG. 5b. The shapes shown in FIGS. 5a and 5c minimize the impact on the available space in valve body 12.

Another possible shape of the cross-section of spacer element 32 suitable to lengthen the path of the pitting from the corrosion trigger zone is a T shape (not shown in the figures). In the case of the L and F shapes, spacer element 32 can also be oriented in a different way than that illustrate. In particular, spacer element 32 can be rotated by 90°, so as to have the longer branch of the L shape oriented perpendicular, as opposed to parallel, to the x-axis.

In brief, the interposition of a spacer element between the fitting and the valve body prevents (or at least reduces) the components of the valve from coming into contact with each other in a zone of the valve exposed to the outside environment and thus prevents (or at least reduces) an electric arc of great intensity from being triggered between these components in damp and saline environments. Any electric arcs that may occur are of lower intensity than would have been triggered. Furthermore, the arc must go around the spacer element (along a path which may be lengthened by changing the shape and dimensions of the spacer element) before it reaches the sealing zone between the valve body and the fitting.

While particular elements, embodiments and applications of the present invention have been shown and described, it will be understood, that the invention is not limited thereto since modifications can be made without departing from the scope of the present disclosure, particularly in light of the foregoing teachings. For example, the various embodiments demonstrate that different combinations of components are possible within the scope of the claimed invention, and these described embodiments are demonstrative and other combinations of the same or similar components can be employed to achieve substantially the same result in substantially the same way.

What is claimed is:

1. A fluid flow regulating device, particularly for automotive gas systems, comprising:
(a) a body made of a first material,
(b) a component coupled to said body and made of a second material different from said first material, and
(c) a spacer element of annular shape between said body and said component,
wherein said spacer element is arranged around said component so as to be in contact on a first side against said body and on a second side against said component, thereby avoiding direct contact between said component and said body in a zone of the device exposed to a surrounding environment, and wherein said spacer element is made of a third material having an electric potential value between that of said first material and of said second material.

2. The device of claim 1, wherein said body has a threaded cylindrical seat and wherein said component comprises a threaded cylindrical coupling portion screwed into said seat.

3. The device of claim 2, wherein said component has an abutment surface lying in a plane perpendicular to an axis of said coupling portion and wherein said spacer element is in contact on a first side against said body and on a second side against said abutment surface.

4. The device of claim 1, wherein said first material is aluminum and said second material is stainless steel.

5. The device of claim 4, wherein said spacer element is made of a metal material.

6. The device of claim 5, wherein said spacer element is made of brass or copper.

7. The device of claim 1, wherein said spacer element has a cross-section of an L-shaped, F-shaped or T-shaped.

8. The device of claim 1, wherein said body is a valve body of a multifunction valve and wherein said component is a fitting for connecting a pipe to said valve body.

9. The device of claim 3, wherein an O-ring is mounted on said component between said coupling portion and said abutment surface and seals against a conical surface of said seat of said valve body.

10. The device of claim 1, wherein said element spacer is sized and shaped with a first portion projecting perpendicularly from a second portion, thereby increasing the distance a pitting corrosion path must travel from a corrosion initiation point in the zone of the device exposed to the surrounding environment to an area of said threaded cylindrical seat.

11. A fluid flow regulating device, particularly for automotive gas systems, comprising:
(a) a body made of a first material and having a threaded cylindrical seat,
(b) a component made of a second material different from said first material and having a threaded cylindrical coupling portion screwed into said seat of said body, and
(c) a spacer element of annular shape between said body and said component,
wherein said spacer element is arranged around said component so as to be in contact on a first side against said body and on a second side against said component, thereby avoiding direct contact between said component and said body in a zone of said device exposed to a surrounding environment, and wherein said spacer element is made of a third material having an electric potential value between that of said first material and of said second material.

12. The device of claim 11, wherein said component has an abutment surface lying in a plane perpendicular to an axis of said coupling portion and wherein said spacer element is in contact on a first side against said body and on a second side against said abutment surface.

13. The device of claim 11, wherein said first material is aluminum and said second material is stainless steel.

14. The device of claim 13, wherein said spacer element is made of a metal material.

15. The device of claim 14, wherein said spacer element is made of brass or copper.

16. The device of claim 11, wherein said spacer element has a cross-section of an L-shaped, F-shaped or T-shaped.

17. The device of claim 11, wherein said body is a valve body of a multifunction valve and wherein said component is a fitting for connecting a pipe to said valve body.

18. The device of claim 12, wherein an O-ring is mounted on said component between said coupling portion and said abutment surface and seals against a conical surface of the seat of said valve body.

19. The device of claim 1, wherein said element spacer is sized and shaped with a first portion projecting perpendicularly from a second portion thereby increasing the distance a pitting corrosion path must travel from a corrosion initiation point in the zone of the device exposed to the surrounding environment to an area of said threaded cylindrical seat.
